(19) United States
(12) Patent Application Publication
(10) Pub. No.: US 2020/0260766 A1
(43) Pub. Date: Aug. 20, 2020

(54) REDUCED FAT AND CALORIE GUACAMOLE FOOD PRODUCT AND PROCESS FOR MAKING THE SAME

(71) Applicants: Maria Dellanina, Mount Prospect, IL (US); Cheryl Fitzgerald, Chicago, IL (US)

(72) Inventors: Maria Dellanina, Mount Prospect, IL (US); Cheryl Fitzgerald, Chicago, IL (US)

(21) Appl. No.: 16/794,823

(22) Filed: Feb. 19, 2020

Related U.S. Application Data
(62) Division of application No. 15/692,250, filed on Aug. 31, 2017, now abandoned.

(51) Int. Cl. A23L 19/00

(52) U.S. Cl. CPC A23L 19/09; A23V 2002/00

(57) ABSTRACT

A reduced fat and calorie guacamole food product and process for making the same. The present invention pertains to a process for making a guacamole food product base using avocadoes, legumes, green vegetables and lime. The present invention also includes specific proportions of the aforementioned ingredients.

### BACKGROUND OF THE INVENTION

The present invention relates to a reduced fat and calorie guacamole food product and process for making the same. More specifically, the present invention pertains to a process for making a base product using avocados, legumes and vegetables such as broccoli and peas. Other flavors may be added to the base product to produce variations on the base product that create for example: (1) a traditional flavor; (2) a mango, mint and onion flavor; (3) a pineapple and watercress flavored product; (4) a smoked barbeque flavor or (5) an Asian flavor.

Guacamole is an avocado-based dip, spread or food product believed to have been developed by the Aztecs in what is now Mexico. The popularity of guacamole has grown considerably over the last several years. The major ingredient of guacamole is raw avocado. Guacamole is traditionally made by mashing avocados and salt using a mortar and pedestal. Lime may also be added.

One of the problems encountered with traditional guacamole is that it has an extremely high calorie and fat content per serving. For example, a typical serving of guacamole is typically about 2 ounces, and may include 90 calories and contain 8 grams of total fat. The typical serving is the equivalent of approximately two golf-ball sized scoop of guacamole, or the amount of guacamole typically placed on four chips. Most people eat much more than the “typical” serving of guacamole which vastly increases the amount of calories and total fat consumed.

Another problem faced by guacamole is the presence of polyphenol oxidate in the cells of the avocado, which when exposed to oxygen, causes an enzymatic reaction which turns the avocado a brownish color.

There is clearly a need to develop a lower calorie, lower fat alternative to a pure avocado-based guacamole. It is accordingly a principal object of the present invention to provide a guacamole substitute product that has a lower calorie and reduced fat content from a pure avocado-based guacamole product.

There is also a need for the guacamole substitute product to have essentially the same taste as a pure avocado-based product.

Another object of this invention is to provide a process for the production of a reduced calorie and fat guacamole substitute product that includes avocados, legumes and vegetables such as broccoli and/or peas. Other objects and advantages of the present invention will become apparent in the course of the following detailed description.

### SUMMARY OF THE INVENTION

The present invention provides a guacamole substitute product which has a reduced fat and calorie content as compared to an equally sized portion of an avocado-based product. The process by which the substitute guacamole product of the present invention may include the steps of: (a) rinsing and draining legumes; (b) processing the legumes (such as cannellini beans) in a food-processor; (c) heating a green vegetable (such as peas and/or broccoli) until tender or have achieved a bright green color; (d) puree the vegetable in food processor and strain the vegetable; (e) removing lima beans from the shell and pureeing the lima beans in a food processor; (f) mashing the inside of a ripe avocado; (g) adding avocado, pureed green vegetable, pureed lima beans, pureed legumes in a food processor with salt and pepper; (h) mixing the ingredients in a food processor; and (i) chilling the mixture to a temperature of approximately 34°-40° Fahrenheit.

The mixture is typically sealed in an air-tight container.

The guacamole base may be amended with other ingredients to make different flavored guacamole products.

### DETAILED DESCRIPTION OF THE PREFERRED EMBODIMENTS OF THE INVENTION

Referring now in detail to the preferred embodiment of the reduced fat and calorie guacamole food product and the process for making the same. Briefly described, in a preferred form, the present invention provides a process and system that produces a reduced fat and calorie substitute guacamole product having an avocado, legume, pea and broccoli base composition. The present process preferably comprises the following steps:

(a) rinsing and draining a fixed amount of legumes, preferably lima beans;

(b) blending the legumes in a food processor until desired consistency;

(c) cooking peas, or other green vegetable, until tender;

(d) straining peas, or other green vegetable;

(e) cutting broccoli into bite-sized florets;

(f) heating broccoli until it is tender;

(g) removing lima beans from shell;

(h) pureeing lima beans in a food processor;

(i) mashing inside of ripe avocado;

(j) mixing legumes, peas, broccoli, lima beans, avocado, onion, salt, pepper and sugar; and

(k) chilling the mixture to approximately 34° to 40° Fahrenheit.

The above steps create what is called a base product. The preferred embodiment of the base product contemplates the use of peas and broccoli in the mixture. Any type of green vegetable may be used such as kale, spinach, swiss chard, artichoke, rappini, celery, brussels sprouts or the like. The green vegetables serve to reduce the caloric and fat content of the food product. The green vegetables should be cooked and the skins may be removed to improve the taste and consistency of the final food product. Additionally, while lima beans are disclosed in the preferred food product, other types of beans may be substituted into the food product including, by way of example, black beans, chick peas, pinto beans, or the like. Several variations of the above process exist in other preferred embodiments. For example, limes may be added to the base product. Other ingredients may be added to the base product to create different flavors. For example, traditional guacamole flavoring may be created using cilantro, tomatoes, cayenne pepper, onion, chile peppers and jalapenos in combination with the base. Additionally, ingredients such as mango, mint, peeled red onion and jalapeno pepper may be combined with the base. Other flavors such as pineapple, watercress, smoked barbeque or Asian seasoning may be added to the base to create additional flavors as desired below. Further, the step of heating the green vegetables may be conducted using a microwave, stove or steam.

The preferred embodiment includes a base product for the reduced fat and calorie guacamole food product while maintaining the taste of a pure avocado-based product. The preferred base, low-fat guacamole product, includes the following ingredients in the expressed weights (all of which are approximated):

TABLE 1
Product Formula Table: Base Product

| | Metric weight | | Standard |
|---|---|---|---|
| Ingredient | in grams | | Formula % |
| Ripe, fresh Avocados, seeded, | 63.00 | g | 20.30% |
| peeled | | | |
| Broccoli, fresh, cooked | 63.00 g | | 20.30% |
| | (35.0 g, stem, | | (11.28%, 9.02%) |
| | 28.0 g | | |
| | florets) | | |
| Green peas, frozen, thawed, cooked | 73.00 | g | 23.52% |
| Baby Lima beans, frozen, thawed, | 31.50 | g | 10.15% |
| cooked | | | |
| Cannellini beans, organic, canned, | 31.50 | g | 10.15% |
| reduced sodium | | | |
| Limes | 25.41 | g | 8.19% |
| White onion, medium, chopped | 19.75 | g | 6.36% |
| fine | | | |
| Ground black pepper | .15 | g | .05% |
| Salt, iodized | 2.37 | g | .76% |
| Cumin, ground | .05 | g | .02% |
| Sugar | .67 | g | .22% |
| | Total Wt. (g) | | Total Wt. % |
| | 310.4 | g | 100.02% |

The preferred base product is produced with specific steps. The first step calls for rinsing limes and green vegetables under tap water for 1 minute and pat dry with a paper towel. Individually weigh pepper, salt, cumin, and sugar. Finely chop onion and individually weigh. Squeeze limes with handheld juice press and weigh lime juice. Open can of cannellini beans with can opener. Drain and rinse beans with strainer saving 2 tablespoons of drained liquid for blending. Place all cannellini beans and the 2 tablespoons of bean liquid into food processor on appropriate setting and process until desired consistency, typically as close to a puree as possible. While, cannellini beans are set forth in the preferred embodiment, it is understood that other types of beans may be used to achieve a similar result. Weigh out the beans.

Place green peas into microwave safe bowl, cover with microwave safe lid, and heat on HIGH for one minute, until bright green. While the preferred method of heating the vegetables is described as using a microwave, the heating step may be performed by heating processes that include a stove, steam, oven, fire or other conventional heating means. Further, while the preferred process calls for the use of peas and broccoli, other types of green vegetables may be substituted without effecting the overall taste, consistency or caloric content of the product. Place the microwaved peas into food processor and process until desired consistency, as close to a puree as possible. Remove peas from food processor and place the heated peas into a metal strainer and strain with a spoon into bowl to remove pea shells. Weigh out strained peas. Peel skin of broccoli stems with vegetable peeler. Chop the stem of broccoli and cut broccoli head into bite sized florets. Place broccoli on to a microwave safe dish. Cover dish and heat in a microwave on HIGH for 1 minute. Check stems for tenderness and microwave for additional 15 sec intervals, as needed, until tender. Florets should be bright green. Place microwaved broccoli and lime juice into food processor and process until desired consistency, as close to a puree as possible.

The green vegetables may be heated to improve the consistency of the green vegetable to more closely approximate the consistency of a ripe avocado.

Remove lima bean shells by hand. Place shelled lima beans into food processor and process until desired consistency, as close to a puree as possible. Weigh out lima bean puree. Of course, while lima beans or cannellini beans are described in the preferred embodiment, other types of beans may be substituted without affecting the overall consistency, taste or caloric content of the food product. The next step in the process involving cutting the avocados in half and removing the seed. Score the inside of the avocado in vertical and diagonal ½ cuts with a knife, around edges and gently squeeze out avocado from flesh. Place avocados in a bowl and weigh, leaving out about a quarter of chunks of avocado to fold in later. Add remaining avocado into food processor with pureed peas, lima beans, cannellini beans, and onions. Turn on and let process for 5 seconds. Add pepper, salt, cumin, and sugar into food processed mixture. Pulse 3 times. Mix with rubber spatula 9 times. Transfer mixture to a bowl. Add avocado chunks to mixture. Fold three times. Cover mixture with absorbent paper towel and plastic wrap, removing air pockets, and cover top of bowl with plastic wrap. Chill in fridge for 30 minutes or longer for flavor development. While the preferred portions of the ingredients are set forth above, the invention is not bound to those proportions.

The final base product of the preferred embodiment should have approximately the following nutritional information for a 310 g (about 11 ounces) serving of the traditional food products:
Fat=2.5 g
Protein=3 g
Calories=70
Fiber=3 g

A typical 300 g serving of guacamole using only avocado would have approximately the following approximated nutritional information:
Fat=40 g
Protein=5 g
Calories=500
   As one can recognize, the fat and caloric content of the preferred food product of the present invention is significantly less than the traditional all avocado food product.

While the preferred steps to create the base reduced fat and calorie guacamole food product are expressed above, other steps may be performed to achieve the same result. For example, the amount of time to heat the green vegetable may vary. Moreover, the step of peeling the broccoli may not be necessary. Additionally, there may be different types of legumes that could be substituted for the cannellini or lima beans described above. Likewise, it is possible to substitute cauliflower for broccoli in the above example. Finally, the precise measurements of products are not necessary to practice the essence of the invention, so long as the necessary consistency of the product is maintained. It is preferred that the avocado portion of the mix be maintained below 25% of the entire compilation to maintain the reduced calorie count and fat content.

There are several flavorings that may be combined with the base. One of the preferred additional flavor that may be combined with the base guacamole food product is a traditional flavoring. The ingredients of the preferred traditional flavoring include the following in the following products in the following approximated proportions (all of which are approximated):

TABLE 2
Product Formula Table: Traditional Flavor

| | | |
|---|---|---|
| | Metric | Standard |
| Ingredient | weight in | Formula % |

| | | | |
|---|---|---|---|
| Base | 310.4 | g | 65.30% |
| Tomatoes, medium, chopped | 120.0 | g | 25.24% |
| White onion, medium, chopped | 23.25 | g | 4.89% |
| fine | | | |
| Fresh garlic, minced | 4.20 | g | .88% |
| Cayenne Pepper | .06 | g | .01% |
| Jalapeno Pepper | 8.91 | g | 1.87% |
| Serrano chile | 5.52 | g | 1.16% |
| Bunch cilantro | 3.03 | g | .64% |

| | |
|---|---|
| Total Wt. (g) | Total Wt. % |

| | | |
|---|---|---|
| 475.37 | g | 99.99% |

The preferred traditional flavor is prepared utilizing the following steps. In making the preferred traditional flavoring the base guacamole food product is prepared as described above. The first step involves rinsing tomatoes and cilantro under tap water for 1 minute and pat dry with a paper towel. The next step requires deseeding the tomatoes by cutting in half and squeezing tomato over a bowl until all seeds are removed. Cover tomatoes with paper towel to remove excess water for 30 minutes. Next, the stems are removed from the cilantro; chop the tomatoes (¼″ cut) and the cilantro and weigh individual ingredients. Individually weigh cayenne pepper. Finely chop onion, serrano chile and jalapeno and individually weigh. Cover onion with paper towel to remove excess water for 30 minutes. Mince garlic and weigh. Remove the base guac product from refrigerator. Add weighed out tomatoes, serrano chile, jalapeno pepper, onion, garlic, cayenne pepper, and cilantro to mixture in bowl. Fold mixture with spatula 10 times and scrape sides of bowl. Fold ingredients 2 more times if needed. Cover mixture with absorbent paper towel and plastic wrap, removing air pockets, and cover top of bowl with plastic wrap. Chill to a temperature of approximately 34° to 40° Fahrenheit usually for 30 minutes or longer for flavor development. While the preferred proportions of the ingredients are set forth in the chart above, the proportions may be varied and achieve the desired results of the present invention.

The nutritional values of a 475 g portion of the traditional flavor is set forth in the approximated values below:
Fat=2.5 g
Protein=3 g
Calories=70
Fiber=3 g

Other preferred flavors include: (1) mango, mint and red onion; (2) pineapple and watercress; (3) smoked barbeque and (4) Asian flavor.

The ingredients for the mango, mint and red onion are set forth in the approximated proportions as follows (all of which are approximated):

TABLE 3
Product Formula Table: Mango, Mint, and Red Onion

| | | |
|---|---|---|
| | Metric weight | Standard |
| Ingredient | in grams | Formu |

| | | | |
|---|---|---|---|
| Base | 310.4 | g | 68.00% |
| Mango, medium, | 113.2 | g | 24.80% |
| chopped | | | |
| Red onion, | 16.25 | g | 3.56% |
| medium, | | | |
| chopped | | | |
| Jalapeno pepper | 8.91 | g | 1.95% |
| Serrano chile | 5.52 | g | 1.21% |
| Mint | 2.17 | g | .48% |

| | |
|---|---|
| Total Wt. (g) | Total Wt. % |

| | | |
|---|---|---|
| 456.45 | g | 100% |

The preferred mango, mint and red onion flavor is prepared utilizing the following steps. First, rinse mango, mint, and peeled red onion under tap water for 1 minute and pat dry with a paper towel. The next step involves chopping the mango by using a metal peeler to remove outer skin. Use a chef's knife to cut the mango into equal pieces. Finely chop red onion, serrano chile, jalapeno pepper, and mint and individually weigh. Remove the base guac product from refrigerator. Add weighed out mango, red onion, serrano chile, jalapeno pepper, and mint to mixture in bowl. Fold mixture with spatula 10 times and scrape sides of bowl. Cover mixture with an absorbent paper towel and plastic wrap, removing air pockets, and cover top of bowl with plastic wrap. Chill in fridge for extra 30 minutes or longer for flavor to development. The proportions of the ingredients set forth above may vary without departing from the invention.

The nutritional values of a 455 g serving of the minty mango flavoring is set forth in the approximated nutritional values below:
Fat=2.5 g
Protein=3 g
Calories=80
Fiber=3 g

The preferred pineapple and watercress flavor contains the following ingredients in the following approximated proportions (all of which are approximated):

TABLE 4
Product Formula Table: Pineapple and Watercress

| | | |
|---|---|---|
| | Metric weight | Standard |
| Ingredient | in grams | Formula % |

| | | | |
|---|---|---|---|
| Base | 310.4 | g | 68.47% |
| Pineapple, chopped | 120.0 | g | 26.47% |
| Jalapeno pepper | 8.91 | g | 1.97% |
| Serrano chile | 5.52 | g | 1.22% |
| Watercress | 8.5 | g | 1.87% |

| | |
|---|---|
| Total Wt. (g) | Total Wt. % |

| | | |
|---|---|---|
| 453.33 | g | 100% |

The preferred pineapple and watercress flavor is prepared utilizing the following steps. First, rinse watercress under tap water for 1 minute and pat dry with a paper towel. Next, chop pineapple by removing the top portion with a chef's knife and peeling the skin of the pineapple off with the same knife. Chop the pineapple into equal pieces. Chop watercress and weigh individually. Finely chop serrano chile and jalapeno and individually weigh. Remove the base guac product from refrigerator.

Add weighed out pineapple, watercress, serrano chile, and jalapeno pepper to mixture in bowl. Fold mixture with spatula 10 times and scrape sides of bowl. Fold ingredients 2 more times if needed. Cover mixture with an absorbent paper towel and plastic wrap, removing air pockets, and cover top of bowl with plastic wrap. Chill in fridge for to a temperature of approximately 34° to 40° Fahrenheit, usually about 30 minutes, or longer for flavor development. The proportions of the ingredients set forth may vary without departing from the invention.

The nutritional value of a 450 g serving of the pineapple and watercress flavor is approximated below:
Fat=2.5 g
Protein=3 g
Calories=70
Fiber=3 g

The preferred Smoked BBQ flavor contains the following ingredients in the following approximated proportions (all of which are approximated):

TABLE 5
Product Formula Table: Smoked BBQ

| | | |
|---|---|---|
| | Metric weight | Standard |
| Ingredient | in grams | Formula % |

| | | | |
|---|---|---|---|
| Base | 310.4 | g | 73.92% |
| Green onion, | 9.5 | g | 2.26% |
| fresh, chopped | | | |
| Red onion, | 23.25 | g | 5.54% |
| medium, | | | |
| chopped | | | |
| Sweet Corn, | 60.0 | g | 14.29% |
| frozen, cooked | | | |
| Cayenne Pepper | .06 | g | .01% |
| Bunch cilantro | 2.03 | g | .48% |
| Liquid Smoke | .22 | g | .05% |

| | |
|---|---|
| Total Wt. (g) | Total Wt. % |

| | | |
|---|---|---|
| 419.89 | g | 99.98% |

The preferred Smoked BBQ flavor is prepared utilizing the following steps. First, rinse green onion, peeled red onion and cilantro under tap water for 1 minute and pat dry with a paper towel. Destem cilantro; chop green onion and cilantro and weigh individually. Finely chop red onion, serrano chile, and jalapeno pepper and individually weigh. Microwave sweet corn on HIGH for 1 minute, covered, in a microwave safe bowl. Weigh out 60.0 g of cooked sweet corn. Remove the base guac product from refrigerator. Add weighed out sweet corn, green onion, red onion, serrano chile, jalapeno pepper, and cilantro to mixture in bowl. Fold mixture with spatula 10 times and scrape sides of bowl. Fold ingredients 2 more times if needed. Cover mixture with absorbent paper towel and plastic wrap, removing air pockets, and cover top of bowl with plastic wrap. Chill in fridge for extra 30 minutes or longer for flavor to development. The proportions of the ingredients set forth may vary without departing from the invention.

The nutritional value of 420 g serving of the smoked BBQ flavor food product is approximated below:
Fat=3 g
Protein=3 g
Calories=80
Fiber=3 g

The preferred Asian flavor contains the following ingredients in the following approximated proportions (all of which are approximated):

TABLE 6
Product Formula Table: Asian

| | | |
|---|---|---|
| | Metric weight | Standard |
| Ingredient | in grams | Formula % |

| | | | |
|---|---|---|---|
| Base | 310.4 | g | 93.15% |
| Sesame seeds, white | 8.12 | g | 2.44% |
| Fresh garlic, minced | 4.20 | g | 1.26% |
| Red Fresno Pepper | 5.52 | g | 1.66% |
| Ginger, fresh, grated | 5.0 | g | 1.50% |

| | |
|---|---|
| Total Wt. (g) | Total Wt. % |

| | | |
|---|---|---|
| 333.24 | g | 100.01% |

The preferred Asian flavor is prepared utilizing the following steps. First, rinse red fresno pepper and ginger under tap water for 1 minute and pat dry with a paper towel. Finely chop red fresno pepper and weigh. Grate ginger and weigh out. Heat a non-stick frying pan to low-medium heat. Add 1 tbsp of white sesame seeds. Using a spatula, stir often. Toast sesame seeds until lightly browned, about 4 minutes. Weigh the ingredients. Remove base guacamole food product from refrigerator. Add weighed out toasted sesame seeds, red fresno pepper, and ginger to mixture in bowl. Fold mixture with spatula 10 times and scrape sides of bowl. Fold ingredients 2 more times if needed. Cover mixture with an absorbent paper towel and plastic wrap, removing air pockets, and cover top of bowl with plastic wrap. Chill in fridge for extra 30 minutes or longer for flavor development. The proportions of the ingredients set forth may vary without departing from the invention.

The nutritional value of a 333 g serving of the Asian flavor food product is approximated below:
Fat=7 g
Protein=5 g
Calories=130
Fiber=6 g

The present invention provides unique reduced calorie and fat guacamole food products that has similar taste to a pure avocado-based product.

The foregoing description of the invention has been directed to particular preferred embodiments for purposes of explanation and illustration. It will be apparent, however, to those skilled in the art, that many modifications and changes in the particular methods and materials may be made without departure from the scope and spirit of the invention. It is applicant's intention in the following claims to cover all such equivalents, modifications and changes that fall within the true spirit and scope of the invention.

1.-16. (canceled)

17. A guacamole food based product having a total composition comprising:
a) legumes having a weight of approximately 20% the total composition;
b) avocado having a weight of approximately 20% of the total composition;
c) green vegetables having a weight of approximately 40% to 50% the total composition;
d) lime juice comprising approximately 8% of the total composition;
e) chopped onion comprising 6% of the total composition;
f) pepper, salt and cumin comprising less than 1% of the total composition; and
g) wherein the composition has a reduced level of fat as compared to an avocado based guacamole.

18.-20. (canceled)

21. The guacamole food based product of claim 17, wherein the avocado consists of fruit without skin or seed that has a consistency of a paste.

22. The guacamole food based product of claim 21 wherein the legumes have a consistency of a paste.

23. The guacamole food based product of claim 22 wherein the green vegetable has the consistency of a paste.

24. The guacamole food based product of claim 23 wherein the green vegetable consists of a combination of peas and broccoli.

25. The guacamole food based product of claim 23 wherein the green vegetable consists of peas.

26. The guacamole food based product of claim 23 wherein the green vegetable consists of broccoli.

27. The guacamole food based product of claim 22 wherein the legumes comprise cannellini beans.

28. The guacamole food based product of claim 22 wherein the legumes comprise the combination of lima beans and cannellini beans.

29. The guacamole food based product of claim 28 wherein the legumes are cooked for a period of time between ten and twenty minutes.

30. The guacamole food based product of claim 23 wherein the combination of the paste of the legumes is the same as the consistency of the past of the avocado.
